(19) United States
(12) Patent Application Publication
(10) Pub. No.: US 2014/0298893 A1
(43) Pub. Date: Oct. 9, 2014

(54) METHOD FOR TESTING THE INTEGRITY OF A HYDROPHOBIC POROUS DIAPHRAGM FILTER

(71) Applicants: Michael Laubstein, Goettingen (DE); Juergen Van Den Boogaard, Dransfeld (DE); Dirk Leiser, Braunschweig (DE)

(72) Inventors: Michael Laubstein, Goettingen (DE); Juergen Van Den Boogaard, Dransfeld (DE); Dirk Leiser, Braunschweig (DE)

(73) Assignee: SARTORIUS STEDIM BIOTECH GMBH, Goettingen (DE)

(21) Appl. No.: 14/240,645

(22) PCT Filed: Jun. 26, 2012
(86) PCT No.: PCT/EP2012/002700

§ 371 Date: May 13, 2014

(30) Foreign Application Priority Data
Aug. 24, 2011 (DE) 10 2011 111 050.3

(51) Int. Cl. G01N 15/08

(52) U.S. Cl. CPC G01N 15/0826
USPC 73/38

(57) ABSTRACT

A method for testing integrity of a hydrophobic, porous diaphragm filter (42) includes arranging the filter (42) in a non-wetted state in a test housing (30) so that the filter (42) divides an upstream housing region (30a) from a downstream housing region (30b), completely filling the upstream housing region (30a) with a test liquid that does not wet the hydrophobic diaphragm filter (42), incompletely filling a reservoir (12) that is connected to a liquid feed line (16) of the test housing (30), charging the reservoir (12) with compressed air at a constant pressure below the intrusion pressure of the filter, and determining a substance flow at the reservoir (12). The substance flow to be determined is a mass flow out of the reservoir (12) determined as a decrease in the overall weight of the reservoir (12).

### BACKGROUND

1. Field of the Invention

The invention relates to a method for testing the integrity of a hydrophobic porous diaphragm filter, comprising the following steps:

arrangement of the diaphragm filter in the non-wetted state in a test housing resistant to internal pressure, in such a way that the diaphragm filter separates an upstream housing region, which is provided with a liquid feedline, from a downstream housing region,

complete filling of the upstream housing region with a test liquid which does not wet the hydrophobic diaphragm filter,

incomplete filling of a reservoir resistant to internal pressure, which is connected to the liquid feedline of the test housing and is connected to a regulatable compressed-air supply,

charging of the reservoir with compressed air at a constant pressure below the intrusion pressure of the diaphragm filter,

determination of a substance stream for the reservoir as a measure of the quantity of test liquid penetrating into and/or through the diaphragm filter.

2. Description of the Related Art

Test methods of this type are known from U.S. Pat. No. 5,786,528 A.

Various test principles are known for determining the integrity of porous diaphragm filters. Mention should be made here, in particular, of the diffusion method (diffusion test), the boiling point method (bubble point integrity test), the intrusion pressure method (intrusion pressure test) and the flow rate method (flow rate test). The latter principle is also known, particularly in the case of hydrophobic diaphragm filters, as the water flow method (water flow test) or, in brief, the WFT method. The present invention relates to such WFT methods.

The abovementioned U.S. Pat. No. 5,786,528 A discloses a WFT method in which a closed filter capsule is introduced into a test housing. The space in the test housing around the filter capsule is flooded, that is to say filled completely, with test liquid, in particular with water. A reservoir connected to the test housing is filled only partially with the test liquid. The diaphragm filter, of which the filter capsule is composed, thus separates a liquid-filled capsule exterior from an empty capsule interior or a liquid-filled housing region from an empty housing region. A gas pressure space is provided above the test liquid level in the reservoir. The line connecting the reservoir and the test housing is filled completely with test liquid. In such a test set-up, the gas pressure space of the reservoir is charged with compressed air. The pressure is in this case set such that the intrusion pressure of the diaphragm filter is not exceeded. The intrusion pressure is understood to mean that pressure which corresponds to the capillary pressure for the largest pores of the diaphragm filter. The intrusion pressure thus constitutes that pressure limit, above which the test liquid can penetrate into the pores of the diaphragm filter, although, in the case of the hydrophobic filter diaphragm under consideration here, it is, overall, its hydrophobic forces which oppose the penetration of a non-wetting liquid, in particular water. By contrast, at a pressure below the intrusion pressure, as provided in the WFT method, the diaphragm filter remains “leaktight” toward the test liquid. Only leakages in the filter would enable a liquid stream to pass through the diaphragm filter.

The liquid stream through the diaphragm filter cannot be measured directly with sufficient accuracy. The known WFT methods therefore measure variables representative of this liquid stream in the region of the reservoir. In this case, above all, two methods are known. In a first method, after an initial pressure has been built up, the supply of compressed gas to the reservoir is stopped and the pressure drop in the reservoir is measured. In a second method, the pressure in the reservoir is kept constant and the gas stream continuing to flow into the reservoir in order to maintain pressure is measured by means of suitable volumetric flow rate measuring instruments. If temperature and non-ideal gas properties, etc. are sufficiently taken into account, the measured pressure drop or the measured gas stream can be converted into a liquid stream at the filter. In this case, it must be remembered that, even in the case of an integral, that is to say “leaktight” filter, a pressure drop or gas volume flow is observed. This arises from structural changes in the diaphragm filter under pressure and from evaporation of the liquid at the pores of the diaphragm filter.

The main disadvantage of the known method is that the conversion of the pressure drop or gas stream at the reservoir into the liquid stream at the diaphragm filter is highly susceptible to error.

A method on the principle of the diffusion test is known from US 2011/0067485 A1. In the diffusion test, a wetted diaphragm filter, that is to say a filter, the pores of which are filled with a wetting liquid, is exposed on one side to a gas pressure below the gas intrusion pressure. The gas intrusion pressure is to be understood here to mean that pressure at which the wetting liquid inside the filter pores is “blown out” due to the prevailing gas pressure. Below this gas intrusion pressure, gas can pass through the filter only by the creep of small gas bubbles through the wetting liquid or by the gas being dissolved and diffused through the wetting liquid. By contrast, if there are leakages, this low pressure is sufficient to “blow out” the wetting liquid. Since the diffusion stream is irrelevant for the integrity of the filter, the publication mentioned proposes to prevent this diffusion stream by flooding the space on the downstream side of the diaphragm filter. The remaining gas stream through the integral filter is then based solely on gas bubble transport, and that through the non-integral filter is in addition to a gas stream caused by the leakages. To measure gas transport, the quantity of liquid which is displaced by the gas penetrating into the space located downstream of the filter is measured gravimetrically. In particular, the weight of that liquid which drops out of a drain in the space downstream of the filter is measured. This method has two substantial disadvantages. On the one hand, it is necessary for the filter to be wetted. Where hydrophobic diaphragm filters are concerned, wetting typically takes place with alcohol. This, on the one hand, entails a risk of explosion and, on the other hand, necessitates lengthy and cost-intensive drying of the filter before its further use. The second disadvantage to be mentioned is the inaccuracy of the method in the case of small filter surfaces. Small filter surfaces result in low displacement of liquid, so that measuring the weight of the volume dropping out of the drain is subject to serious error.

The object of the present invention is to develop a generic method in such a way that quicker and more accurate integrity testing of hydrophobic porous diaphragm filters becomes possible.

### SUMMARY OF THE INVENTION

This invention relates to a method for testing the integrity of a hydrophobic porous diaphragm filter where substance stream to be determined is a mass flow out of the reservoir which is determined as a decrease in the overall weight of the reservoir.

The invention is first aimed at the direct measurement of the (liquid) mass flow out of the reservoir. The conversion, susceptible to error, of a pressure drop or of a gas volume flow into a liquid stream consequently becomes unnecessary. Measurement takes place gravimetrically, but in this case liquid placed, for example, behind the filter or liquid which has penetrated through the filter is not intercepted downstream of the filter and weighed. Instead, weighing is carried out upstream of the filter, the entire reservoir being weighed. Any weight decrease can be interpreted as test liquid which has flowed out of the reservoir to the filter. As a result, inaccuracies, such as occur in the capture of drops on account of the process of drop formation and because of possible evaporation, are avoided.

Thus, by means of the proposed method, quick and accurate integrity measurement is made available for hydrophobic diaphragm filters which, in particular, does not necessitate the wetting of the filter.

In a preferred embodiment of the invention, there is provision whereby, to determine the overall decrease in mass of the reservoir, its weight is measured as a function of time and the gradient of the latter is determined. This means, in other words, that the overall weight of the reservoir is measured at different time points, in particular in discrete time intervals, and these measurement values are stored. The gradient, that is to say the change in weight per unit time, is then determined from several measurement values. This corresponds to a mass flow which can be given, for example, in gram per minute units.

This gradient, that is to say the mass flow, is also preferably determined as a function of time. This may take place, for example, by the repeated determination of the in each case current gradient value of a sliding regression straight line over a plurality of weight measurement values. In other words, for example when each new weight measurement value is recorded, a regression straight line through the current and a predetermined number of preceding weight measurement values is calculated and the gradient of this straight line is determined. The curve resulting from a plurality of gradient values determined successively in this way represents the behavior of the mass flow over time. The significance of this curve for deciding on the integrity of the filter becomes clear when the physical phenomena in the test set-up become apparent. First of all, expandable elements of the apparatus, such as, for example, hoselines, expand when charged with pressure. Simultaneously, presupposing that the pressure in the reservoir is regulated to be constant, processes are revealed which are initially caused essentially by structural changes experienced when the diaphragm filter to be tested is under pressure. In particular, the diaphragms of complex filter devices, such as, for example, filter candles or filter capsules, are folded multiply. Pleated filters are also spoken of. This pleating first changes very quickly under pressure and later markedly more slowly into a final configuration. Thereafter, above all, evaporation effects of the test liquid become noticeable at the pores of the diaphragm filter. The phenomena described, lead in the first place to a rapid sudden decrease in the overall rate of the reservoir, and this decrease becomes continuously weaker until the decrease in mass reaches a static state. The mass flow correspondingly decreases continuously and approaches a constant value. In other words, the measured weight values run out into a straight line with a constant gradient, where appropriate with a constant gradient of zero.

To decide on the integrity of the diaphragm filter, preferably the gradient function, but alternatively also the weight function is compared with corresponding reference profiles. The reference profiles can be stored and filed for different filter types. The comparison in this case preferably takes place in an automated way, the special comparison criteria having to be defined beforehand according to requirements.

The reservoir is preferably arranged on a weighing dish of an electronic balance which is calibrated after the filling of the test housing and before the reservoir is charged with pressure. The large measuring range of electronic weighing cells is thereby utilized advantageously.

Beneficially, the reservoir is arranged so as to be higher than the test housing. This ensures that the test housing and the feedline between the reservoir and test housing are flooded completely during filling, so that gas-filled dead volumes are avoided in these regions.

Further features and advantages of the invention will be gathered from the following special description and the accompanying drawings.

### BRIEF DESCRIPTION OF THE DRAWINGS

FIG. 1 shows a diagrammatic illustration of a set-up for carrying out the method according to the invention,

FIG. 2 shows a representation of curves to illustrate the preferred evaluation in the context of the method according to the invention.

### DETAILED DESCRIPTION OF THE PREFERRED EMBODIMENTS

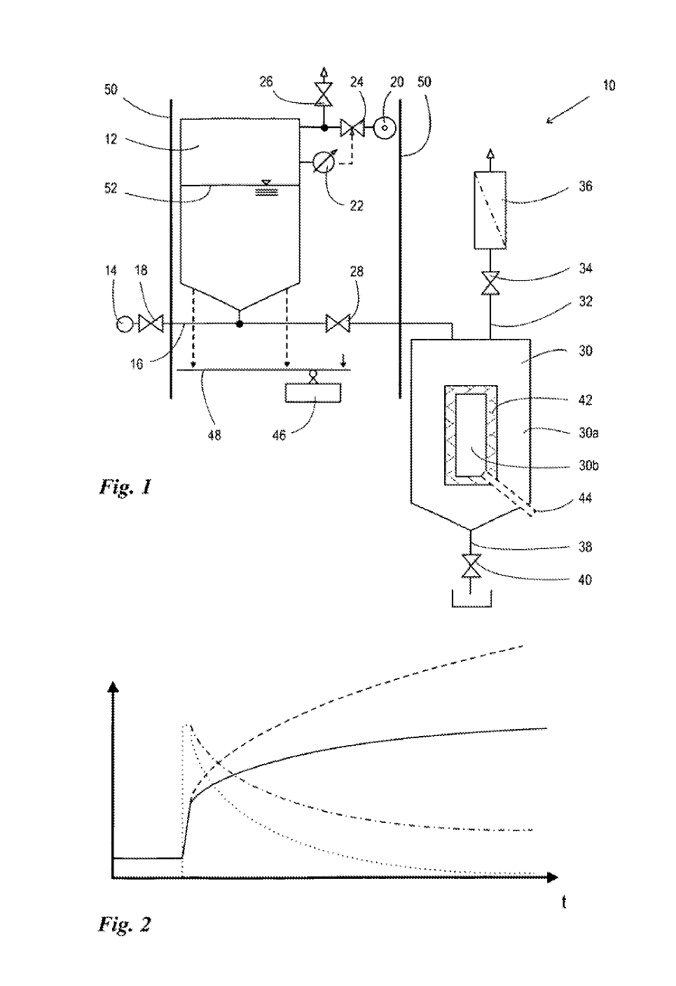

FIG. 1 shows a diagrammatic illustration of a plant 10 for carrying out the method according to the invention. The plant 10 comprises a reservoir 12 which can be filled with test liquid, in particular with demineralized water, from a source 14, not illustrated in any more detail, via a filling line 16 which has a stop valve 18. The reservoir 12 is connected, further, to a compressed air source 20, the pressure inside the reservoir 12 being regulatable to stipulated values via a controller 22 and a regulatable compressed air valve 24. The compressed air connection has, further, a compressed air discharge valve 26.

Via the filling line 16, which after its connection to the reservoir 12 has a further stop valve 28, a test housing 30 is connected, which, with the stop valves 18 and 28 open, can likewise be filled with test liquid, in particular demineralized water, from the source 14. In the preferred embodiment shown in FIG. 1, the test housing 30 is positioned at a lower level than the reservoir 12, thus ensuring that the test housing 30, when being filled, is first flooded completely before filling of the reservoir 12 commences. A vent line 32, which has a dedicated stop valve 34 and exhaust-air filter 36, ensures, further, that no gas-filled dead volume remains when the test housing 30 is flooded. The test housing 30 preferably also has a dedicated discharge line 38 with a dedicated stop valve 40.

A diaphragm filter 42 can be mounted inside the test housing 30 such that it separates two housing regions from one another in terms of pressure. In the embodiment shown, a filter capsule closed on all sides is shown, which separates an outer region 30a of the test housing 30 from an inner region 30b. When the test housing 30 is in the flooded state, the outer housing region 30a is filled with the test liquid and the inner region 30b is filled with gas under atmospheric pressure. Optionally, the gas-filled region 30b of the test housing 30 may be connected to the surroundings via an exhaust-air line 44.

The reservoir 12 is positioned on an electronic weighing device 46 which is capable of recording weight values of the reservoir 12 continuously or periodically and of sending them to a control and calculation unit, not illustrated. For this purpose, the weighing device 46 comprises a weighing dish 48 which, in the preferred embodiment shown in FIG. 1, is equipped with windshield walls 50 to reduce faults.

To carry out an integrity test on the filter capsule 42, first, with the stop valves 18 and 28 of the filling line 16 open, with the exhaust-air valve 34 open and with the discharge valve 40 closed, the test housing 30 is flooded. The outer space 30a of the test housing 30 is in this case filled completely with test liquid. This does not penetrate through the hydrophobic diaphragm filter of the filter capsule 42. Air originally contained in the test housing can escape via the exhaust-air line 32. After the flooding of the test housing 30, its exhaust air-valve 34 is closed and the reservoir 12 is filled up to a stipulated level 52. The level 52 is selected such that there remains above the level line a gas space which is sufficiently large for building up a pneumatic pressure.

After these preparations, the stop valve 18 of the filling line 16 is closed and the electronic weighing device 46 is calibrated. The reservoir 12 is subsequently charged with a regulated constant pressure from the compressed air source 20. This pressure is selected such that the intrusion pressure of the hydrophobic diaphragm filter of the filter capsule 42 is not exceeded. In other words, in the integral filters, no test liquid can flow through the pores of the hydrophobic diaphragm filter into the inner region 30b of the test housing 30. Nevertheless, because of the charging with pressure, a liquid stream out of the reservoir 12 occurs. This liquid stream comprises a plurality of components. On the one hand, depending on the choice of material, there may be a pressure-induced expansion of individual elements, in particular of the filling line 16 which can then receive more liquid which has to be redelivered from the reservoir 12. On the other hand, particularly in the case of complexly shaped, for example pleated diaphragm filters, there is a structural change in the pleating, so that the filter capsule 42 can, overall, receive more liquid which likewise has to be redelivered from the reservoir 12. Finally, there are evaporation effects at the pores of the hydrophobic diaphragm filter, thus resulting in losses through the filter diaphragm which likewise have to be compensated from the reservoir 12. Moreover, in the event of a leakage, a continuous stream of liquid through the filter diaphragm occurs. All this leads to a decrease in the overall weight of the reservoir 12, that is to say in the sum of the pure reservoir weight and of the weight of the test liquid contained in the reservoir 12. This weight decrease is recorded by the electronic weighing device 46.

FIG. 2 shows as an unbroken line the graph of the weight profile in time of the reservoir 12, represented as an amount for the purpose of the logarithmic scaling of the ordinate. The first, sharp rise of the curve corresponds to a first weight loss which is mainly due to the structural changes of the testpiece. The curve subsequently has a degressively rising profile. Depending on the pore size, the temperature and the boiling point of the test liquid, this curve runs, in the context of the respective measurement accuracy, toward a constant value or into a straight line with a very low gradient.

The corresponding gradient value over time is represented by dots in FIG. 2. This gradient curve corresponds to the mass flow out of the reservoir 12 which, after the conclusion of the dynamic structural change phase, that is to say in the right part of the curve, corresponds to the mass flow at the diaphragm filter. The curve runs into a constant value near to or into zero.

The overall weight profile of the reservoir 12 in the case of a non-integral filter is represented by dashes in FIG. 2. The curve runs out into a straight line with a marked gradient. The corresponding gradient curve or mass flow curve is represented in FIG. 2 by dashes and dots. The high constant final value of the mass flow curve corresponds to a constant stream through a leak in the diaphragm filter.

In order to reach a decision on the integrity of the filter 42, a case-related evaluation of the weight profile curve and/or of the mass flow curve is required. In particular, what is appropriate here is a comparison with stored reference curves which have been recorded for different filter types on filters of identical type of construction which are known to be integral. For example, the undershooting of a stipulated gradient level at one or more stipulated time points could be assessed as an indication of the absence of leakages of specific sizes. This assessment can be carried out in an automated way in software if the corresponding rules are defined. Particularly when a plurality of comparison time points are adopted, not only can a qualitative integral/non-integral decision be made, but also conditionally quantitative evidence as to the pore size of the filter 42 can be given.

The embodiments discussed in the special description and shown in the figures represent, of course, only illustrative exemplary embodiments of the present invention. A broad spectrum of variation possibilities is obvious to a person skilled in the art in light of the disclosure made here. In particular, the integrity testing method is not restricted to filter capsules of the type shown. Even simpler or more complicated filter forms can be tested in this way. The person skilled in the art will be able to adapt the required mounting in the test housing to the respective circumstances without difficulty.

1. A method for testing the integrity of a hydrophobic porous diaphragm filter (42), comprising the following steps:
arranging the diaphragm filter (42) in the non-wetted state in a test housing (30) resistant to internal pressure, in such a way that the diaphragm filter (42) separates an upstream housing region (30a), which is provided with a liquid feedline (16), from a downstream housing region (30b),
completely filling the upstream housing region (30a) with a test liquid which does not wet the hydrophobic diaphragm filter (42),
incompletely filling a reservoir (12) resistant to internal pressure, which is connected to the liquid feedline (16) of the test housing (30) and is connected to a regulatable compressed-air supply (20, 22, 24, 26),
charging the reservoir (12) with compressed air at a constant pressure below the intrusion pressure of the diaphragm filter,
determining of a substance stream for the reservoir (12) as a measure of the quantity of test liquid penetrating into and/or through the diaphragm filter (42),
wherein the substance stream to be determined is a mass flow out of the reservoir (12), which is determined from a decrease in the overall weight of the reservoir (12).

2. The method of claim 1, wherein to determine the overall decrease in mass of the reservoir (12), its weight is measured as a function of time and the gradient of the weight is determined.

3. The method of claim 2, wherein the gradient is determined as a function of time.

4. The method of claim 3, wherein the gradient function is determined by a repeated determination of each current gradient value of a sliding regression straight line over a plurality of weight measurement values.

5. The method of claim 3, wherein a decision on the integrity of the diaphragm filter (42) takes place in an automated way based on a comparison of the gradient function with stored reference profiles.

6. The method of claim 1, wherein the reservoir (12) is arranged on a weighing dish (48) of an electronic balance (46) which is calibrated after the filling of the test housing (30) and before the reservoir (12) is charged with pressure.

7. The method of claim 1, wherein the reservoir (12) is arranged to be higher than the test housing (30).
